(19) United States
(12) Patent Application Publication
(10) Pub. No.: US 2026/0304302 A1
(43) Pub. Date: Oct. 1, 2026

(54) NETWORK EVENT EXPOSURE IN ROAMING SCENARIOS

(71) Applicant: InterDigital Patent Holdings, Inc., Wilmington, DE (US)

(72) Inventors: Kevin Di Lallo, Laval (CA); Michael Starsinic, Newtown, PA (US); Michel Roy, Candiac (CA); Debashish Purkayastha, Eagleville, PA (US); Taimoor Abbas, Sainte-Julie (CA); Atle Monrad, Froland (NO)

(73) Assignee: InterDigital Patent Holdings, Inc., Wilmington, DE (US)

(21) Appl. No.: 19/092,909

(22) Filed: Mar. 27, 2025

(51) Int. Cl. H04W 48/18; H04W 8/20; H04W 84/04

(52) U.S. Cl. CPC H04W 48/18; H04W 8/20; H04W 84/042

(57) ABSTRACT

Methods for use in an event reporting gateway function (ERGF) network node are provided. For example, an ERGF receives, from an event reporting network function (ERNF) in a first public land mobile network (PLMN), an event notification request upon detection of an event in the first PLMN for which a network function (NF) in a second PLMN has subscribed to. The event notification request includes information associated with the detected event and information associated with the NF in the second PLMN. The ERGF obtains an event reporting policy (ERP) from a unified data repository (UDR). The ERP is associated with the NF in the second PLMN. The ERGF sends an event notification to the NF in the second PLMN. The event notification includes information associated with the detected event that has been normalized by the ERGF network node based on the ERP.

### BACKGROUND

The 5G core network (5GC) supports a monitoring capability for exposing network events externally (e.g., to authorized external applications) and internally (e.g., to core network functions). For external event exposure, a network exposure function (NEF) provides the monitoring capability services.

### SUMMARY

An event reporting gateway function (ERGF) network node that may reside in a first public land mobile network (PLMN) is disclosed, along with methods performed by the ERGF. In one embodiment, the ERGF may receive from an event reporting network function (ERNF) in the first PLMN, an event notification request upon detection of an event in the first PLMN for which a network function (NF) in a second PLMN has subscribed to. The event notification request may include information associated with the detected event in the first PLMN and information associated with the NF in the second PLMN. The ERGF may obtain an event reporting policy (ERP) from a unified data repository (UDR). The ERP may be associated with the NF in the second PLMN. The ERGF may send an event notification to the NF in the second PLMN. The event notification includes information associated with the detected event in the first PLMN that has been normalized by the ERGF network node based on the ERP.

The ERGF may process the information associated with the detected event in the first PLMN received in the event notification request by adding information, deleting information, or modifying information, based on the ERP, to produce the information associated with the detected event in the first PLMN that has been normalized.

In some embodiments, the information associated with the detected event in the first PLMN that has been normalized by the ERGF network node based on the ERP prevents information associated with the first PLMN from being shared with the NF in the second PLMN.

In some embodiments, the information associated with the NF in the second PLMN includes a public land mobile network (PLMN) identifier (ID) associated with the NEF, a network function (NF) ID, an endpoint, or a correlation ID.

In some embodiments, the ERP includes event matching criteria, event filtering rules, or event normalization rules.

In some embodiments, the event matching criteria enables the ERGF network node to determine that the detected event in the first PLMN is associated with an event filtering rule or an event normalization rule in the ERP.

In some embodiments, the event filtering rules enable the ERGF network node to select an action for the information associated with the detected event in the first PLMN.

In some embodiments, the event normalization rules enable the ERGF network node to add information, delete information, or modify information to the information associated with the detected event in the first PLMN.

In some embodiments, the ERGF network node may obtain an ERP from a UDR by sending one or more of an identifier of the ERGF network node, a user equipment (UE) identifier, a user identity, an event identifier, or information associated with the NF in the second PLMN to the UDR.

In some embodiments, the ERGF network node may send, to the ERNF in the first PLMN, an event notification response indicating whether a successful event notification was sent to the NF in the second PLMN.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram that shows an example of event exposure interactions in a 5G local breakout (LBO) roaming scenario;

FIG. 3 is a system diagram that shows an example of event exposure interactions in a 5G home-routed (HR) roaming scenario;

FIG. 4 is a system diagram of an example ERGF deployment as a core network function;

FIG. 5 is a signal flow diagram of a network event exposure utilizing the disclosed ERGF; and

FIG. 6 is a method flow diagram of an example method performed by an ERGF.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

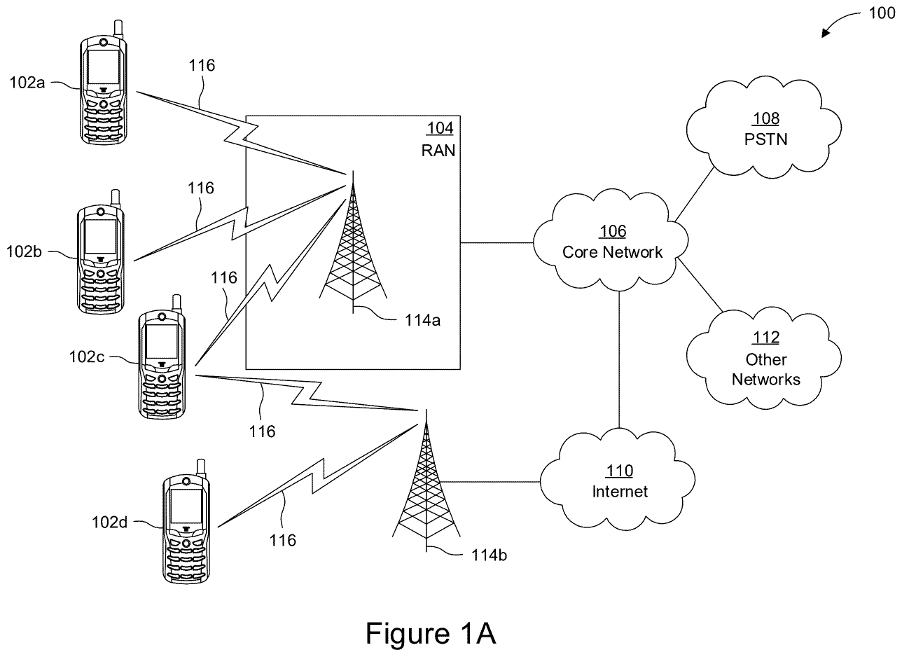

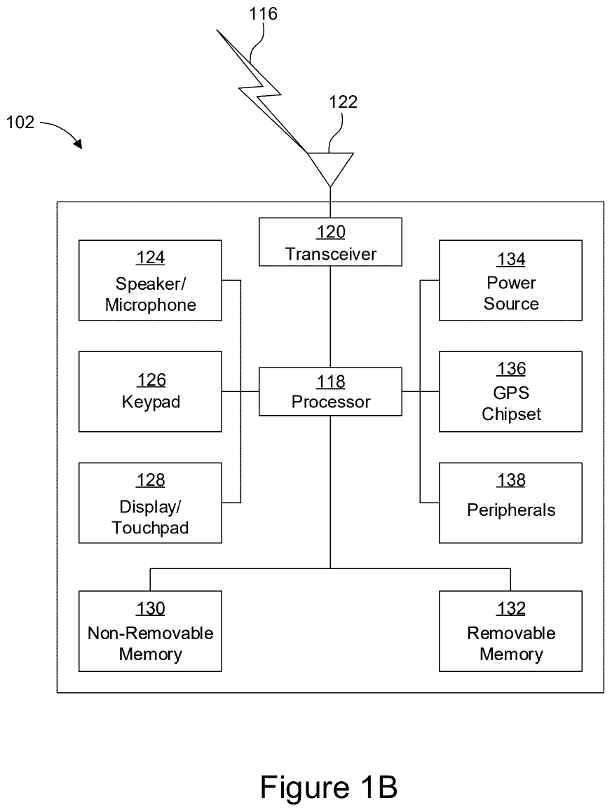

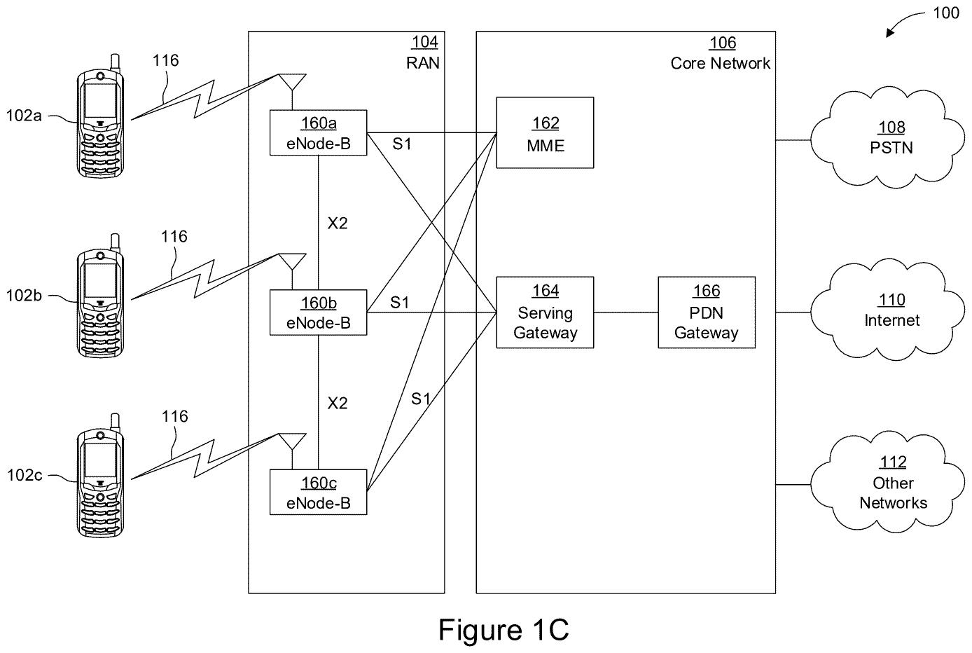

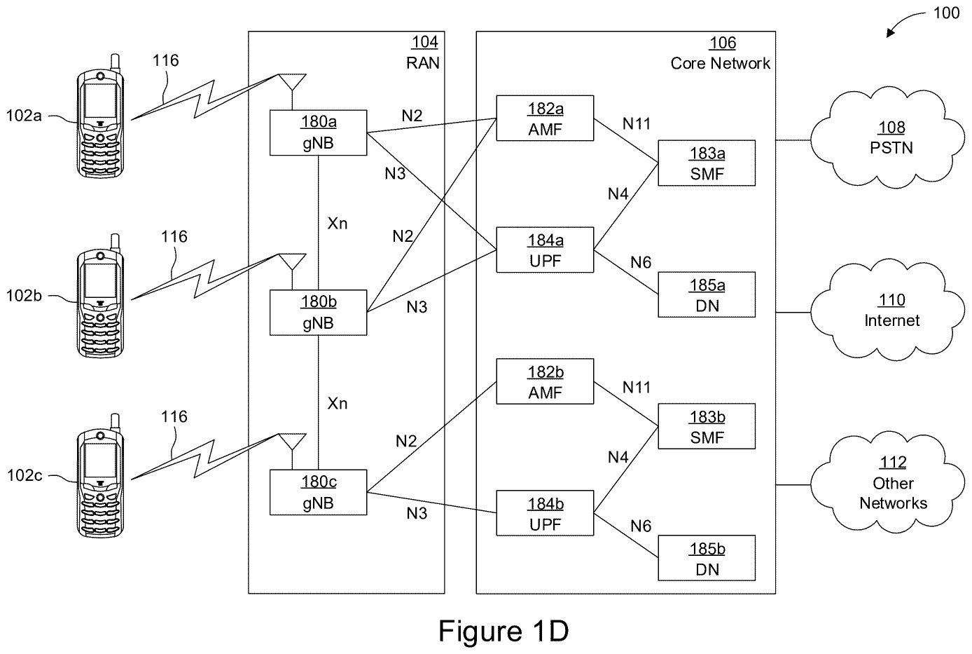

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As used herein, the following acronyms have the following meaning:
3GPP 3rd Generation Partnership Project
5G 5th Generation
5GC 5G Core Network/5G Core
5GS 5G System
6G 6th Generation
6GC 6G Core Network/6G Core
6GS 6G System
AC Application Client
AF Application Function
AN Access Network
API Application Programing Interface
AS Application Server
CN Core Network
DN Data Network
DNN Data Network Name
ERGF Event Reporting Gateway Function
ERNF Event Reporting Network Function
ERP Event Reporting Policy
GPSI Generic Public Subscription Identifier
H-NEFHPLMN NEF
HPLMN Home PLMN
ID Identifier
IP Internet Protocol
ISG Industry Specification Group
MNO Mobile Network Operator
NAI Network Access Identifier
NEF Network Exposure Function
NF Network Function
PLMN Public Land Mobile Network
QoS Quality of Service
RAN Radio Access Network
RAT Radio Access Technology
SBI Service-Based Interface
S-NSSAI Single Network Slice Selection Assistance Information
SUPI Subscription Permanent Identifier
TS Technical Specification
UDM Unified Data Management
UDR Unified Data Repository
UE User Equipment
V-NEFVPLMN NEF
VPLMN Visited PLMN

The terms “AS” and “AF” may be used interchangeably herein. The terms “network event”, “event report” and “event notification” may be used interchangeably herein. The terms “network function” and “network function instance” may be used interchangeably herein. An event notification target is a network node (for example, a network functional entity, an application server, or an enabler server) that is the target of event notifications. Information about the event notification target may include a PLMN ID, NF ID (for example, NEF ID), endpoint (for example, FQDN, URI, IP address, port), and a correlation ID.

As used herein, the term “service bus” may be a functional entity allowing various NFs to communicate with each other. A service bus may be implementation specific. A service bus may be any interconnection allowing NFs to communicate with each other. A NF may communicate with other NFs via a service bus or a NF may communicate with a service bus to reach another NF. The terms ‘communicating with a service bus’ or ‘communicating via a service bus’ may be used interchangeably herein.

As mentioned above, the 5G core network (5GC) supports a monitoring capability for exposing network events externally (e.g., to authorized external applications) and internally (e.g., to core network functions). For external event exposure, a network exposure function (NEF) provides the monitoring capability services.

For event exposure via an NEF, the NEF subscribes to one or more event reporting network function (ERNF) (e.g., UDM, AMF, SMF, UPF, or any other NF from the CN that can generate an event report) either directly or via an intermediate NF (for example, UDM). While subscribing to an ERNF, the NEF provides an event ID, event filter information, event reporting information, and information about the event notification target described herein.

When the ERNF detects an event, the ERNF sends an event notification to the event notification target. If the ERNF determines that the event notification target belongs to a different PLMN, the ERNF may normalize the event report before sending it to the event notification target. Normalization involves modifying the event report to include, exclude, and/or change the reported information according to (i.e. based on) the roaming agreement between the participating PLMNs. Normalization may be used to avoid exposing information about the architecture or structure of a network, and/or may be used to avoid exposing information about the internal workings of a network.

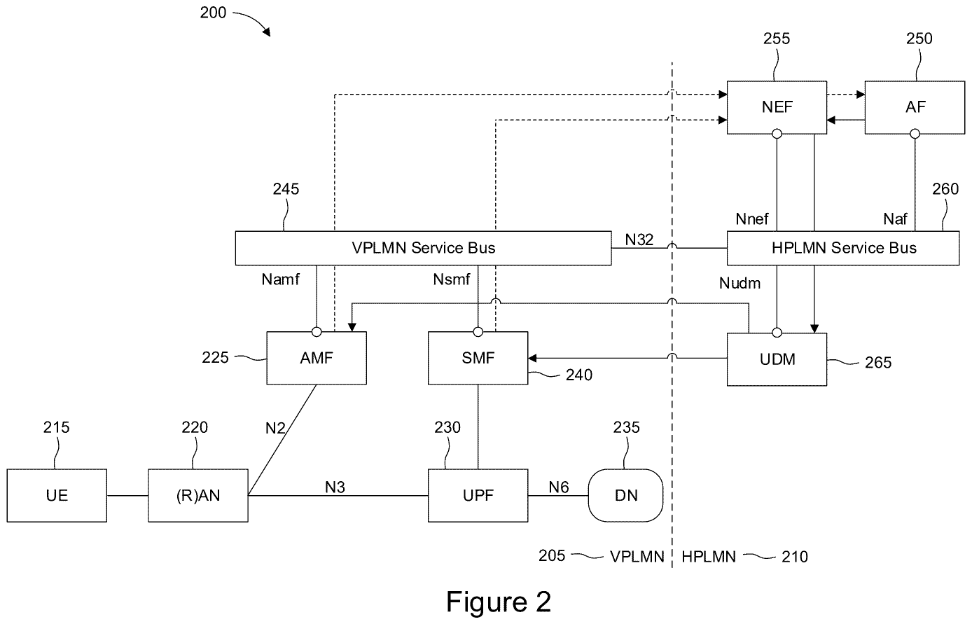

FIG. 2 shows an example of event exposure interactions in a 5G local breakout (LBO) roaming scenario. In FIG. 2, a VPLMN 205 and an HPLMN 210 are shown. In the VPLMN 205, a UE 210 is in wireless communication with an AN, such as a RAN 220. The access network, such as RAN 220 is connected to an AMF 225 and a UPF 230, which is in turn in communication with a DN 235. UPF 230 is in communication with SMF 240, and AMF 225 and SMF 240 are in communication with the VPLMN service bus 245. In the HPLMN 210, an AF 250 is in communication with an NEF 255 and an HPLMN service bus 260. HPLMN 210 also includes a UDM 265. In the system shown in FIG. 2, event exposure subscription requests are shown using solid arrow lines and event exposure notifications are shown using dashed arrow lines.

In this example of event exposure interactions in a 5G LBO roaming scenario, the AF 250 in the HPLMN 210 may wish to receive event reports about connectivity and PDU session status for UE 215, for example, that is roaming with an LBO PDU session in VPLMN 205. The AF 250 may subscribe for events via a NEF 255 in the HPLMN 210. The NEF 255 may determine that the request involves a roaming UE 215 and may subscribe for events from a UDM 265 in the HPLMN 210. The UDM 265 may determine that the required event information involves an AMF 225 and an SMF 240 in the VPLMN 205, and the UDM 265 may subscribe for network events from the AMF 225 and SMF 240.

When the ERNF (for example, operating in the AMF 225 and/or SMF 240) detects a network event, the ERNF may normalize the event report according to the roaming agreement between the HPLMN 210 and VPLMN 205. The ERNF may then send the normalized event report to the event notification target (e.g., the NEF 255 in the HPLMN 210). Finally, the NEF 255 may send the event report to the AF 250 that initially subscribed for network event notification.

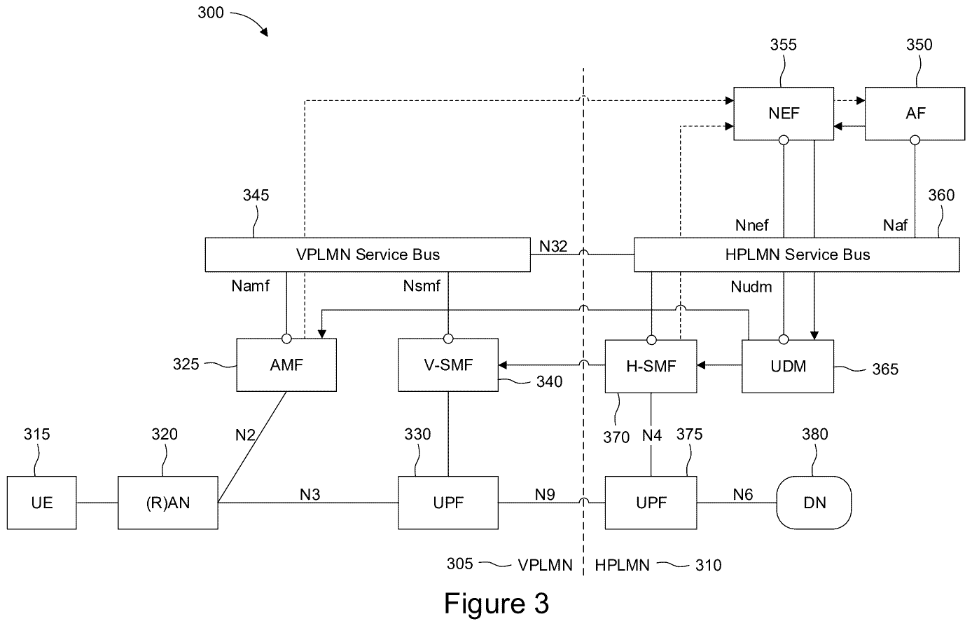

FIG. 3 shows an example of event exposure interactions in a 5G home-routed (HR) roaming scenario. In FIG. 3, a VPLMN 305 and an HPLMN 310 are shown. In the VPLMN 305, a UE 315 is in wireless communication with an AN, such as a RAN 320. The access network, such as RAN 320 is connected to an AMF 325 and a UPF 330. UPF 330 is in communication with a UPF 375 in HPLMN 310 and ultimately the DN 380. UPF 330, in VPLMN 305, is in communication with V-SMF 340, and AMF 325 and V-SMF 340 are in communication with the VPLMN service bus 345. In the HPLMN 310, an AF 350 is in communication with an NEF 355 and an HPLMN service bus 360. HPLMN 310 also includes a UDM 365 and an H-SMF 370, both of which are in communication with the HPLMN service bus 360. In FIG. 3, event exposure subscription requests are shown using solid arrow lines and event exposure notifications are shown using dashed arrow lines.

In this example of event exposure interactions in a 5G home-routed (HR) roaming scenario, an AF 350 in HPLMN 310 may wish to receive event reports about connectivity and PDU session status for UE 315 that is roaming with an HR PDU session in VPLMN 305. The AF 350 may subscribe for events via a NEF 355 in HPLMN 310. The NEF 355 may determine that the request involves a roaming UE and may subscribe for events from UDM 365 in the HPLMN 310. The UDM 365 may determine that the required event information involves an AMF 325 and an SMF 340 in the VPLMN 305, and the UDM 365 may subscribe for network events from the AMF 325 and SMF 340 (for example, via a H-SMF 370 in the HPLMN 310).

When the ERNF (for example, operating in the AMF 325 and/or SMF 340 in the VPLMN 305) detects a network event, the ERNF may normalize the event report according to the roaming agreement between the HPLMN 310 and VPLMN 305. The ERNF may then send the event report to the event notification target (for example, the NEF 355 in the HPLMN 310). Finally, the NEF 355 may send the event report to the AF 350 that initially subscribed for network events.

In some embodiments, a Network Repository Function (NRF), not shown in FIG. 3, acts as a centralized service registry and provides a discovery mechanism for Network Functions (NF). The NRF maintains an updated repository of available NFs and their supported services, allowing newly deployed NFs to register and existing ones to discover required services dynamically. As part of the NF discovery procedures, the NRF performs network function selection and may consider aspects such as service load, optimal service location, slice information and policies to ensure secure and efficient service discovery. The NRF may communicate with other NFs via the service bus over the Service-Based Interface (SBI) via HTTP and RESTful APIs.

In current wireless systems, an event reporting network function (ERNF) may be aware of roaming agreements to properly process (for example, normalize) event reports exchanged across PLMN boundaries. For example, an ERNF may be pre-provisioned with information, policies and rules based on roaming agreements and related to the processing of network events in roaming scenarios. Support for such roaming-specific capabilities increases the complexity of ERNFs.

It is expected that next generation wireless systems will enable monitoring and exposure of more network events from existing and new ERNFs. For example, an AN, for example a RAN, may wish to expose monitoring capabilities and may report access network events to service consumers via the service bus. To support additional ERNF types, wireless systems will need to provision and enforce roaming agreement policies and rules in a growing number of ERNFs.

Accordingly, there is a need for wireless systems to reduce the complexity of ERNFs and to enable efficient provisioning and enforcement of roaming agreement policies and rules. System enhancements are desired to consolidate roaming-specific event reporting capabilities and to enable policy-based inter-PLMN event reporting.

The embodiments provided herein implement enhancements to consolidate management of network event reporting in roaming scenarios. The described embodiments aim to reduce the complexity of ERNFs and to enable policy-based inter-PLMN event reporting.

An Event Reporting Gateway Function (ERGF) is described herein, as an enhancement to current wireless systems, to process inter-PLMN event reports based on roaming agreements. An ERNF in a VPLMN may use an ERGF to process and forward event notifications targeting a Network Exposure Function (NEF) in a HPLMN. The ERGF may retrieve an Event Reporting Policy (ERP) stored in a Unified Data Repository (UDR) and may process event reports according to the ERP. The ERP may be based on a roaming agreement between one or more HPLMN and VPLMN. The ERP may include rules for normalization of event reports.

Procedures are described herein to manage ERGF registration and discovery, to manage ERP storage and provisioning, and to process inter-PLMN event reporting via an ERGF. Enhancements to the wireless core network to enable consolidated, policy-based inter-PLMN event reporting are described. These enhancements are embodied in an ERGF described herein.

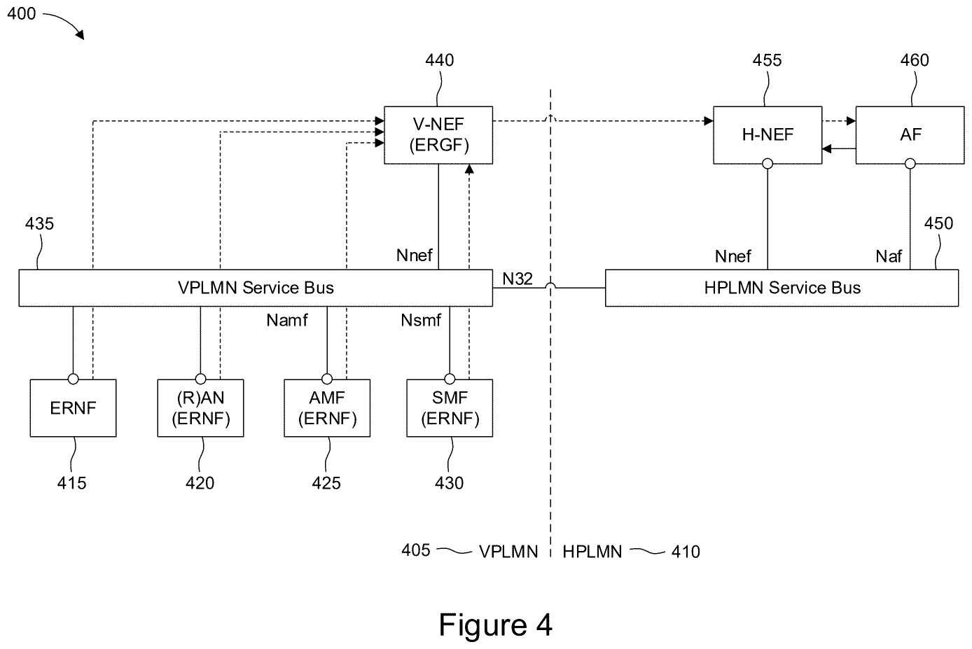

FIG. 4 shows an example of a deployment 400 of the ERGF as a core network function. In this deployment, the V-NEF 440 (for example, the NEF in the VPLMN 405) performs the functions of an ERGF, and the core network functions that generate network events perform the functions of the ERNF (for example, ERNF 415, RAN ERNF 420, AMF ERNF 425, and SMF ERNF 430). When a network event is detected by an ERNF (for example, ERNF 415, RAN ERNF 420, AMF ERNF 425, and SMF ERNF 430) in a VPLMN 405 and when the event notification target is in a HPLMN 410, the ERNF may discover and select a V-NEF 440 (for example, with ERGF capabilities). The ERNF (for example, ERNF 415, RAN ERNF 420, AMF ERNF 425, and SMF ERNF 430) may then send the detected network event to the V-NEF 440 for processing based on an ERP. Finally, the V-NEF 440 sends the event report to the H-NEF 455 in HPLMN 410, and the H-NEF 455 reports the network event to the AF 460 in the HPLMN 410. Detailed procedures are described below.

In another embodiment of the ERGF, an H-NEF (for example, NEF in the HPLMN) may perform the functions of an ERGF. When a network event is detected by an ERNF in an HPLMN and when the event notification target is in a VPLMN, the ERNF may discover and select an H-NEF (for example, with ERGF capabilities). The ERNF may then send the detected network event to the H-NEF for processing based on an ERP. Finally, the H-NEF sends the event report to the V-NEF (for example, an NEF in a VPLMN), and the V-NEF reports the network event to the AF in the VPLMN.

In a wireless network, an ERGF may provide event exposure services to ERNFs. Event exposure services may include procedures for ERGF management (for example, registration and discovery), ERP provisioning, event report processing (for example, filtering and normalization) and event reporting across PLMN boundaries.

The ERGF may offer event exposure services via an Application Programming Interface (API). The ERGF functionality may be implemented as a standalone Network Function (NF). The ERGF functionality may be combined with an existing NF, and the API may be offered as an extension of an existing API, and the API may be based on a service-based interface (SBI).

The ERGF services may be offered using a communication protocol. For example, the Hyper Text Transfer Protocol (HTTP) for 3GPP systems may provide access to the capabilities of the ERGF services.

The ERGF may be located in the network (for example, in an AS, AF, NF, or other network component). A consumer ERNF may use the ERGF functionality provided by the ERGF.

The ERGF functionality may be packaged in a library that is statically linked with a NF or dynamically loaded by a NF.

An ERGF may utilize an ERP. An ERP is a policy that indicates how to process and handle event reports. An ERP may be based on operator preferences and requirements and may be based on roaming agreements between one or more HPLMN and VPLMN. An ERP may include event matching criteria, event filtering rules, and event normalization rules.

Event matching criteria is used to identify matching event reports. Event matching criteria may include one or more of an event ID, an event type, a source NF ID, a source NF type, a target NF ID, a target NF type, a target AF ID, a target AF type, a source PLMN ID, a target PLMN ID, an event reporting information, and/or an event type specific information (for example, UE information, location information, service information).

Event filtering rules may indicate the actions that an ERGF may apply to the matching event reports. Actions may include accepting, rejecting, and/or delaying an event report notification. The event report may be discarded if the event report is delayed, and a new event report is received before it is sent.

Event normalization rules may indicate specific event report information to add, remove or modify in an inter-PLMN event report. The event report information to normalize may be identified using event information matching criteria. Event information matching criteria may include event information type and PLMN-specific detection criteria. Event normalization rules may apply to event reports identified using the event matching criteria or to all event reports.

An ERP may be stored in a UDR. An NF may query the UDR and provide any combination or subset of a consumer identifier, a PLMN ID, a UE ID, a User Identity, an Event ID, and/or information about an event notification target as a key when querying the UDR. In response to the query, the UDR may provide an ERP that is associated with the combination or subset of a consumer identifier, a PLMN ID, a UE ID, a User Identity, an Event ID, and/or information about an event notification target. In other words, the UDR may provide an ERP that describes how to process an event that is associated with the consumer identifier, the PLMN ID, the UE ID, the User Identity, the Event ID, and/or the information about an event notification target.

The consumer identifier identifies the requesting NF. The PLMN ID identifies the PLMN to which an event report may need to be sent. For example, the PLMN ID identifies the H-NEF to which the event report may need to be sent. The UE ID identifies the UE that the event report is associated with. The User Identity identifies the user to whom the event report is associated. The Event ID identifies the type of event report (for example, a reachability report or a location report) that may need to be sent to the event notification target (for example, the H-NEF). The information about an event notification target may include information that characterizes the target of event notifications (for example, the H-NEF). For one PLMN ID, there may be multiple associated UE IDs, and for each UE ID there may be one or more associated event IDs. Similarly, a User Identity may be associated with multiple event IDs.

The ERP may indicate that no event report may be sent to the event notification target (for example, an H-NEF). The ERP may indicate that an event report may be sent to the event notification target (for example, an H-NEF) and that some or all the information in the event report does not need to be normalized. The ERP may indicate that an event report may be sent to the event notification target (for example, an H-NEF) and that some or all of the information in the event report must be normalized. If the ERP indicates that information in the event report needs to be normalized, then the ERP may indicate how, or to what degree, the information needs to be normalized.

For example, the ERP may indicate that location information can be provided with no greater than a certain accuracy or latency. And/or the ERP may indicate that Cell Identifiers should not be reported. And/or the ERP may indicate that certain timer values should not be reported. And/or the ERP may indicate that timing information such as a time when the UE returned to Idle Mode, an Active Time, a Periodic Update Timer value, and/or an eDRX cycle value, should not be reported. And/or the ERP may indicate that timing information such as a time when the UE returned to Idle Mode, an Active Time, a Periodic Update Timer value, and/or an eDRX cycle value should be changed or rounded to less accuracy before the information is sent in a report. And/or the ERP may indicate that a DNN or DNAI should not be included in a report. And/or the ERP may indicate that the event report should include an indication that data is being excluded from the event report. In this instance, an event report may include an indication that a DNN or DNAI was intentionally left out of the report. The ERP may further indicate that an event report can be sent, but that the event report can provide no other information about the event report. For example, the event report may indicate that the UE is reachable but not provide information about how long the UE is anticipated to remain reachable or about the UE's location.

Processing event reports based on an ERP provides advantages to the network that sends the event report. The network operator that configures the ERP is able to configure the ERP so that information about internal operation or architecture of the network is not exposed to another network operator or third party.

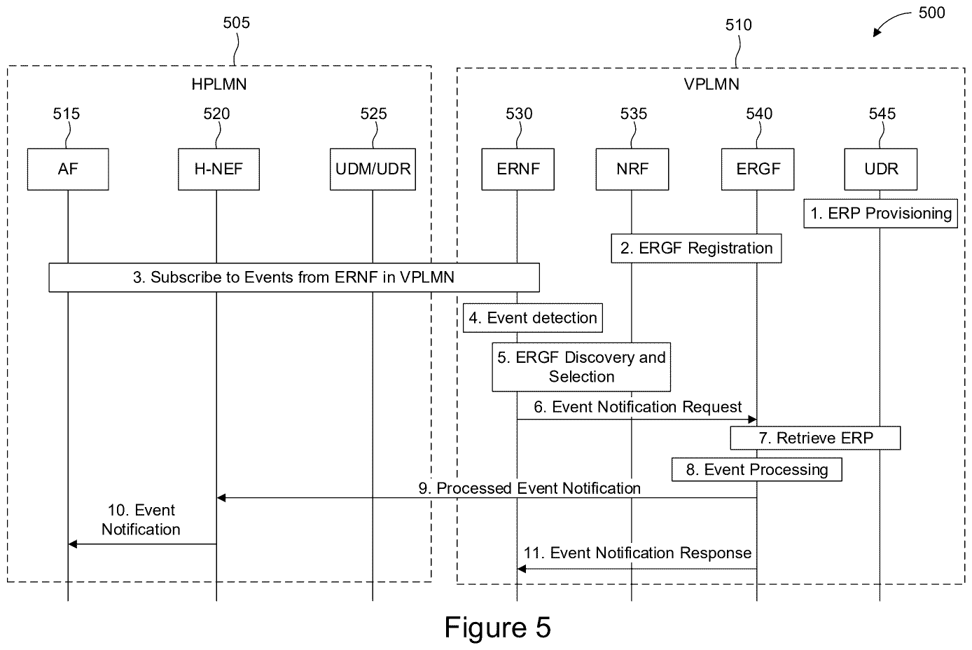

The above described embodiments support event exposure from an ERNF, via an ERGF, to an AF in another PLMN. Referring to FIG. 5, the above embodiments are applied in for exposing network events in a roaming scenario. FIG. 5 shows a signal flow diagram 500, where an ERP is created based on a roaming agreement between a HPLMN 505 and a VPLMN 510. The ERP is then stored in a UDR 545. An AF 515 in a HPLMN 505 subscribes to network event reporting, via a H-NEF 520, from an ERNF 530 in a VPLMN 510. When an event is detected at the ERNF 530, the ERNF 530 discovers and selects an ERGF 540. The ERNF 530 sends an event notification request to the ERGF 540 for processing. The ERGF 540 retrieves the ERP from the UDR 545 and uses the ERP to determine whether the event report should be filtered and/or normalized before being sent to the H-NEF 520. The ERGF 540 performs the determined actions and sends the resulting event notification to the H-NEF 520 in the HPLMN 505. The H-NEF 520 processes and forwards the event notification to the AF 515. Finally, the ERGF 540 indicates to the ERNF 530 whether the event notification was successfully processed and sent.

As a prerequisite, a roaming agreement between the HPLMN 505 and the VPLMN 510 has been established. The roaming agreement includes information, policies and rules related to inter-PLMN event reporting.

Still referring to FIG. 5, in step 1, a UDR 545 in the VPLMN 510 may be provisioned with an ERP as described herein. The ERP may be created based on information obtained from the roaming agreement between the HPLMN 505 and VPLMN 510. The ERP may be stored in the UDR 545 using existing UDR service procedures with enhancements to the UDR data. Enhancements may include a new or enhanced data sets, data subsets, data keys and data subkeys to store and retrieve an ERP. There may be multiple ERPs created and stored in the UDR. There can be multiple ERPs per PLMN, UE, user and/or event. ERPs may be PLMN specific, UE specific, user specific, event specific and/or location specific (for example, ERNF location, or UE location). ERPs may include a priority to manage conflicting ERPs, where a higher priority ERP is utilized over a lower priority ERP.

In some embodiments, a roaming agreement between an HPLMN and a VPLMN may indicate that location reports from the VPLMN for a group of UEs should be normalized to modify the tracking area granularity. An ERP may be created for storage in a VPLMN UDR based on this roaming agreement that may include the necessary event matching criteria and normalization rules to meet the requirements of the roaming agreement. The VPLMN may store the ERP in the UDR for subsequent retrieval and enforcement by an ERGF.

In step 2, the ERGF 540 in the VPLMN 510 may register with the NRF 535 in the VPLMN 510. For example, the ERGF 540 may be instantiated by the management system of the wireless system and may be configured to register with the NRF 535 upon instantiation. Registration with the NRF 535 may include an identifier of an ERGF 540 instance, a NF type (for example, ERGF type), endpoint information (for example, FQDN, URI, IP address, port) and a PLMN identifier.

Upon receiving the registration information, the NRF 535 may store the provided registration information in a NF instance profile and make the ERGF 540 available for discovery. The NRF 535 may return an indication of the registration status and a registration identifier for the management of the registration.

While not shown in FIG. 5, the ERGF 540 may use the registration identifier to subsequently update or delete its registration in the NRF 535.

It should be appreciated that the ERP provisioning and ERGF registration steps may occur in a different order.

In step 3, an AF 515 in the HPLMN 505 may use the event exposure services of the H-NEF 520 (for example, a NEF in the HPLMN) to monitor network events in the wireless system. Monitored events may include events exposed from the wireless core network functions (for example, existing events from the 5GC NFs, new events from future 5GC NFs, new events from next generation core network functions). Monitored events may be UE independent or may be specific to a single UE or a group of UEs. Based on the requested event ID and type, the H-NEF 520 may determine that one or more NFs should be monitored. The H-NEF 520 may subscribe to network events from one or more NFs.

If the monitored event requires event detection in the VPLMN 510, the H-NEF 520 and/or other NFs in the HPLMN 505 may subscribe to events from NFs (for example, ERNFs) in the VPLMN 510. The event exposure subscription requests include information about the event notification target described herein.

Not shown in the figure, the ERNF 530 may send a request to the ERGF 540 to determine if the event subscription request received by the ERNF 530 should be accepted or rejected. The request sent to the ERGF 540 may include any information from the event subscription request. The ERGF 540 may use this information and the ERP to determine if the requested event reporting subscription should be accepted or rejected. The ERGF 540 may send a response to the ERNF 530 indicating whether the event subscription should be accepted or rejected.

For example, an AF 515 in a HPLMN 505 may subscribe for UE reachability and PDU session status events associated with a roaming UE in the VPLMN 510. In this case the AF 515 subscription is done via a NEF in the HPLMN (for example, H-NEF 520). For the requested events, the H-NEF 520 subscribes for event exposure from the UDM 525, and the UDM 525 then subscribes for event exposure from the SMF in the HPLMN 505 and from the AMF in the VPLMN 510. The AMF in the VPLMN 510 then performs the functions of an ERNF to report detected events.

In step 4, an ERNF 530 detects an event associated with a subscription from an AF 515, H-NEF 520, and/or another NF in the HPLMN 505. For example, an AMF performing the functions of an ERNF may detect a change in UE reachability.

In step 5, the ERNF 530 discovers an ERGF 540 in the VPLMN 510. The ERNF 530 may send an NF discovery request to the NRF 535 to discover an ERGF 540. The request may include an identifier of an ERGF instance, a NF type (for example, ERGF type), and information about the event notification target. The NRF 535 may use the information in the NF discovery request to identify and select an ERGF instance that matches the requested information. The NRF 535 sends a NF discovery response to the requesting ERNF 530 and includes information associated with the selected ERGF instance, including the ERGF instance profile, identifier and endpoint.

In some embodiments, the ERGF discovery and selection step (step 5) may occur before ERNF event detection.

In step 6, the ERNF 530 sends and Event Notification request to the ERGF 540. The request may include the event report for the detected event and information about the notification.

For example, the ERNF 530 may detect PDU session inactivity for a roaming UE. The ERNF 530 may generate the event report, discover and select an ERGF, and send the event report to the selected ERGF for further processing (such as ERGF 540). The ERNF 530 indicates the H-NEF endpoint and HPLMN ID where the event notification should be sent when processed (i.e. H-NEF 520 as the endpoint and HPLMN 505).

In step 7, the ERGF 540 sends a Data Management Query request to the UDR 545 to retrieve the ERP. The request may include a consumer identifier (for example, an ERGF ID), a PLMN ID, a UE ID, a User Identity, an Event ID, and information about the event notification target. The UDR 545 may use the information provided in the request to identify a matching ERP by comparing the provided information with the stored data keys and sub keys. The UDR 545 may send a Data Management Query response to the ERGF 540 with the identified ERP. The decision to retrieve the ERP form the UDR 545 may be based on detecting that the event notification target that the report needs to be sent to is in a different PLMN. The decision to retrieve the ERP form the UDR may be based on detecting that the UE, that is associated with the event report, is a subscriber of a different PLMN.

In some embodiments, the ERGF 540 may be pre-provisioned with an ERP.

In step 8, the ERGF 540 processes the event report according to the ERP. The ERGF 540 may determine that the event report matches the event matching criteria in the ERP. The ERGF 540 may determine that the event report information matches the event information matching criteria from the event normalization rules in the ERP. The ERGF 540 may filter (for example, accept, reject, delay) event reports according to the event filtering rules in the ERP. The ERGF 540 may normalize (for example, add information to, remove information from, modify information in) an event report according to the event normalization rules in the ERP.

For example, an ERP may indicate that location information in location reports should be normalized by changing the location granularity from cell level to an HPLMN-specific level. In this case, the ERP may include event matching criteria for location reporting events (for example, event ID and/or event type). The ERP may include event normalization rules indicating cell level information as the event information matching criteria and indicating HPLMN-specific location granularity level as the normalized information output. The ERGF may use this ERP to enforce the roaming agreement policies and rules.

In step 9, the ERGF 540 sends a Processed Event notification to the event notification target (for example, the H-NEF 520). The notification may include the event report received from the ERNF 530. The event report information may be normalized based on the ERP that was received from the UDR as described herein.

For example, the event report may include an indication that information in the event report has been normalized or that information has been left out of the event report. The event report may also include an indication that the information in the event report has been normalized or that information has been left out of the event report because of a configuration (for example, a configuration that was agreed on by the HPLMN 505 and VPLMN 510).

Not shown in the figure, other NFs in the HPLMN 505 may have subscribed for event reporting from the ERNF 530. In embodiments, the event notification target may differ from the H-NEF 520, however the event reporting procedure remains the same, where event notifications are first sent to the ERGF 540 before being sent to the event notification target.

In step 10, the H-NEF 520 sends an event notification to the AF 515 that initially subscribed for network events.

In step 11, the ERGF 540 sends an Event Notification response to the ERNF 530. The response indicates whether the ERGF 540 successfully processed and sent the event report to the H-NEF 520. In a failure case, an error code may be provided with additional information about the cause of failure. For example, if there was an error while processing the event in the ERGF 540, the ERGF 540 may respond to the ERNF 530 with an error code indicating the error. For example, failure to perform normalization could generate an error which prevents the event notification from being sent to the HPLMN 505. In this case, the ERNF 530 may decide to remove the subscription or to adjust subsequent event reports to avoid the reported issues.

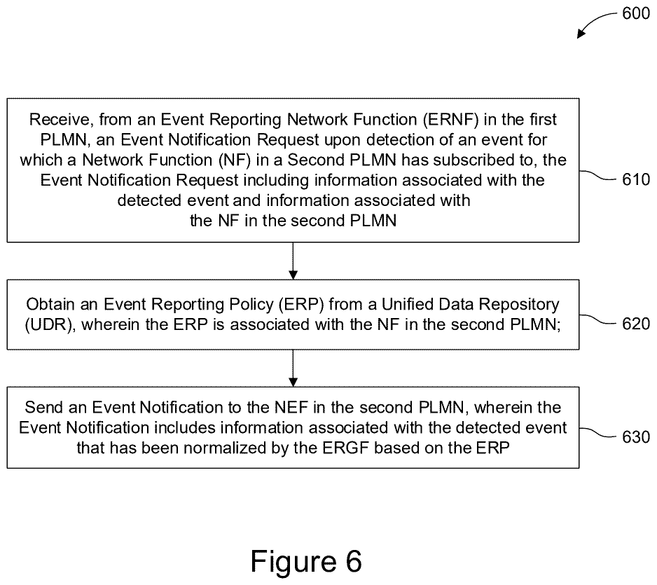

Referring to FIG. 6, a method 600 performed by an ERGF is described. At step 610, the ERGF may receive, from an event reporting network function (ERNF) in the first PLMN, an event notification request upon detection of an event in the first PLMN for which a network function (NF) in a second PLMN has subscribed to. The event notification request may include information associated with the detected event in the first PLMN and information associated with the NF in the second PLMN. At step 620, the ERGF may obtain an event reporting policy (ERP) from a unified data repository (UDR). The ERP may be associated with the NF in the second PLMN. At step 630, the ERGF may send an event notification to the NF in the second PLMN. The event notification may include information associated with the detected event in the first PLMN that has been normalized by the ERGF based on the ERP.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in an event reporting gateway function (ERGF) network node in a first public land mobile network (PLMN), the method comprising:
receiving, from an event reporting network function (ERNF) in the first PLMN, an event notification request upon detection of an event in the first PLMN for which a network function (NF) in a second PLMN has subscribed to, wherein the event notification request includes information associated with the detected event in the first PLMN and information associated with the NF in the second PLMN;
obtaining an event reporting policy (ERP) from a unified data repository (UDR), wherein the ERP is associated with the NF in the second PLMN; and
sending an event notification to the NF in the second PLMN, wherein the event notification includes information associated with the detected event in the first PLMN that has been normalized by the ERGF network node based on the ERP.

2. The method of claim 1, further comprising:
processing the information associated with the detected event in the first PLMN received in the event notification request by adding information, deleting information, or modifying information, based on the ERP, to produce the information associated with the detected event in the first PLMN that has been normalized.

3. The method of claim 1, wherein the information associated with the detected event in the first PLMN that has been normalized by the ERGF network node based on the ERP prevents information associated with the first PLMN from being shared with the NF in the second PLMN.

4. The method of claim 1, wherein the information associated with the NF in the second PLMN includes a public land mobile network (PLMN) identifier (ID) associated with the NF, a network function (NF) ID, an endpoint, or a correlation ID.

5. The method of claim 1, wherein the ERP includes event matching criteria, event filtering rules, or event normalization rules.

6. The method of claim 5, wherein the event matching criteria enables the ERGF network node to determine that the detected event in the first PLMN is associated with an event filtering rule or an event normalization rule in the ERP.

7. The method of claim 5, wherein the event filtering rules enable the ERGF network node to select an action for the information associated with the detected event in the first PLMN.

8. The method of claim 5, wherein the event normalization rules enable the ERGF network node to add information, delete information, or modify information to the information associated with the detected event in the first PLMN.

9. The method of claim 1, wherein obtaining an ERP from a UDR includes sending one or more of an identifier of the ERGF network node, a user equipment (UE) identifier, a user identity, an event identifier, or information associated with the NF in the second PLMN to the UDR.

10. The method of claim 1, further comprising:
sending, to the ERNF in the first PLMN, an event notification response indicating whether a successful event notification was sent to the NF in the second PLMN.

11. A event reporting gateway function (ERGF) network node in a first public land mobile network (PLMN), the ERGF comprising:
a processor; and
a transceiver, wherein the processor and the transceiver are configured to:
receive, from an event reporting network function (ERNF) in the first PLMN, an event notification request upon detection of an event in the first PLMN for which a network function (NF) in a second PLMN has subscribed to, the event notification request including information associated with the detected event in the first PLMN and information associated with the NF in the second PLMN;
obtain an event reporting policy (ERP) from a unified data repository (UDR), wherein the ERP is associated with the NF in the second PLMN; and
send an event notification to the NF in the second PLMN, wherein the event notification includes information associated with the detected event in the first PLMN that has been normalized by the ERGF network node based on the ERP.

12. The ERGF network node of claim 11, wherein the processor and the transceiver are further configured to process the information associated with the detected event in the first PLMN received in the event notification request by adding information, deleting information, or modifying information, based on the ERP, to produce the information associated with the detected event in the first PLMN that has been normalized.

13. The ERGF network node of claim 11, wherein the information associated with the detected event in the first PLMN that has been normalized by the ERGF network node based on the ERP prevents information associated with the first PLMN from being shared with the NF in the second PLMN.

14. The ERGF network node of claim 11, wherein the information associated with the NF in the second PLMN includes a public land mobile network (PLMN) identifier (ID) associated with the NF, a network function (NF) ID, an endpoint, or a correlation ID.

15. The ERGF network node of claim 11, wherein the ERP includes event matching criteria, event filtering rules, or event normalization rules.

16. The ERGF network node of claim 15, wherein the event matching criteria enables the ERGF network node to determine that the detected event in the first PLMN is associated with an event filtering rule or an event normalization rule in the ERP.

17. The ERGF network node of claim 15, wherein the event filtering rules enable the ERGF network node to select an action for the information associated with the detected event in the first PLMN.

18. The ERGF network node of claim 15, wherein the event normalization rules enable the ERGF network node to add information, delete information, or modify information to the information associated with the detected event in the first PLMN.

19. The ERGF network node of claim 11, wherein obtaining an ERP from a UDR includes sending one or more of an identifier of the ERGF network node, a user equipment (UE) identifier, a user identity, an event identifier, or information associated with the NF in the second PLMN to the UDR.

20. The ERGF network node of claim 11, wherein the processor and the transceiver are further configured to send, to the ERNF in the first PLMN, an event notification response indicating whether a successful event notification was sent to the NF in the second PLMN.
